(19) United States
(12) Patent Application Publication
(10) Pub. No.: US 2003/0149638 A1
(43) Pub. Date: Aug. 7, 2003

(54) Parts ordering system for improving efficiency of parts delivery by estimating the order of the parts

(76) Inventors: Masaji Itou, Tokyo (JP); Tsuneo Sekiguchi, Tokyo (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/346,165

(22) Filed: Jan. 17, 2003

(30) Foreign Application Priority Data
Feb. 4, 2002 (JP) 2002-26410

(51) Int. Cl. G06F 17/60

(52) U.S. Cl. 705/26

(57) ABSTRACT

The invention provides parts ordering system with which parts manufacturers can optimize the inventory and easily establish production schedules. The parts ordering system comprises a database for storing predicted required amount of parts received from a plurality of purchasers; a computer programmed to calculate predicted amount of orders of the parts within a predetermined period based on said predicted required amount, and to calculate fixed amount of orders of the parts in response to receiving fixed required amount from the purchasers; and communication means for sending to the suppliers, via communication network, data on the orders of a first delivery time when said fixed amount of orders is less than said predicted amount of orders and sending to the suppliers, via communication network, data on the orders of a second delivery time when said fixed amount of orders exceeds said predicted amount of orders, wherein said second delivery time is longer than said first delivery time.

### TECHNICAL FIELD

The present invention relates to parts ordering system and in particular to parts ordering system for predicting amount of orders of parts to improve the efficiency of the delivery of parts.

### BACKGROUND OF THE INVENTION

According to conventional parts ordering systems, parts orders received from purchasers such as domestic dealers are collected almost once a month to place a fixed order to parts suppliers such as brand manufacture's own factories or parts manufacturers. The suppliers deliver the parts with predetermined delivery time based on the fixed order.

However, since the suppliers may violate the predetermined delivery time if they receive a great deal of order beyond their manufacturing capacity, the suppliers must prepare for such the order by holding a large amount of parts stock to keep the delivery time. It is desirable that such parts stock be minimized in terms of cost and management. In addition, if the amount of parts which will be firmly ordered may be estimated beforehand, parts suppliers may easily make their production schedules.

Therefore, there exists a need for parts ordering system for rightsizing the inventory of the suppliers and facilitating to make the production schedules by sending to the suppliers the predicted amount of orders within a predetermined period in advance and applying different delivery times depending on the difference between the actual fixed amount of orders and the predicted amount of orders.

### SUMMARY OF THE INVENTION

Parts ordering system according to the present invention comprises a database for storing predicted required amount of parts received from a plurality of purchasers. The system further comprises a computer programmed to calculate predicted amount of orders of the parts within a predetermined period based on said predicted required amount and send data on said predicted amount of orders to suppliers via a communication network, and to calculate fixed amount of orders of the parts in response to receiving fixed required amount from the purchasers. The system further comprises communication means for sending to the suppliers, via the communication network, data on the orders of a first delivery time when said fixed amount of orders is less than said predicted amount of orders and sending to the suppliers, via the communication network, data on the orders of a second delivery time when said fixed amount of orders exceeds said predicted amount of orders, wherein said second delivery time is longer than said first delivery time.

According to this invention, since data on the predicted amount of orders may be sent to the parts suppliers before the order becomes fixed, the parts suppliers may easily make their production schedules. When the fixed order is less than the predicted amount of orders, basic delivery time is applied. It is expected that the suppliers may shorten the delivery time in comparison with conventional parts ordering systems. When the fixed amount of orders exceeds the predicted amount of orders, a second delivery time longer than the basic delivery time is applied. Thus, the suppliers do not need to hold excessive stocks.

Preferably, said predicted amount of orders is assigned a unique base number and said fixed amount of orders is assigned an identification number including said base number, wherein both said base number and said identification number are sent to the suppliers. Thus, the suppliers may easily judge which predicted amount of orders corresponds to the received fixed order. Alternatively, a part of the identification number may be different depending on whether the fixed amount of orders exceeds the predicted amount of orders.

According to another aspect of the invention, a difference adjusting process is performed when cumulative amounts of the fixed orders for the predetermined period does not reach said predicted amount of orders. The difference adjusting process refers to, for example, a process for temporarily storing the excess parts at a brand manufacturer's warehouse.

### BRIEF DESCRIPTION OF THE DRAWINGS

FIG. 1 is a block diagram illustrating parts ordering system according to the invention;

FIG. 2 is a flowchart for a calculating process of the predicted amount of orders; and

FIG. 3 is a flowchart for a calculating process of the fixed amount of orders.

### DETAILED DESCRIPTION OF THE PREFERRED EMBODIMENTS

Some embodiments of the invention will be described with reference to the attached drawings.

Parts ordering system according to the invention is administrated by a brand manufacturer such as motor companies. The parts ordering system collects orders for the parts from purchasers such as oversea or domestic distributors of the brand manufacture and sends data on the collected orders to suppliers such as manufacture's own factories or outside parts manufacturers via communication networks.

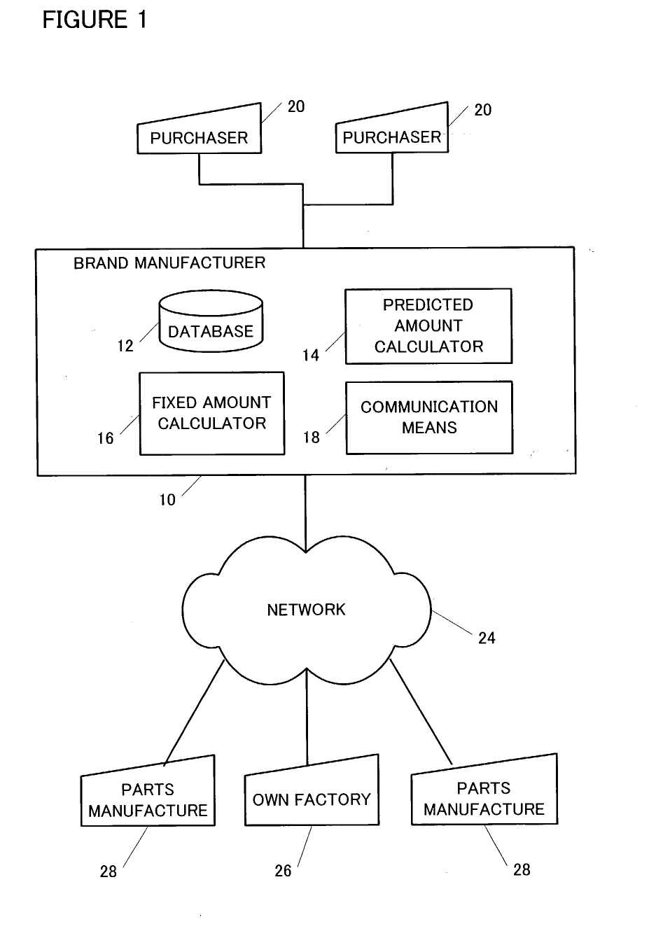

FIG. 1 is a block diagram illustrating the configuration of the parts ordering system. The parts ordering system 10 comprises a database 12 for storing the data including predicted required amount and fixed required amount received from the purchasers, a computer including predicted amount calculator 14 for calculating predicted amount of orders within a predetermined period and fixed amount calculator 16 for calculating fixed amount of orders of parts, and communication means 18 for receiving the predicted required amount and the fixed required amount from the purchasers and transmitting the predicted amount of orders and fixed amount of orders to the suppliers. It should be noted that the term “required amount” refers to an amount of the parts required by a purchaser and the term “amount of orders” refers to an amount of the parts to be actually supplied by a supplier.

The parts ordering system 10 may be implemented by a computer or a server including CPU, memory, storage devices and communication interfaces.

The parts ordering system 10 and terminals 20 installed at the purchasers are connected via INS (International Network System), for example. The parts ordering system 10 is connected with a network 24 such as Internet or intranet. The network 24 is connected with computer terminals 26, 28 installed at suppliers. The terminals 20, 26 and 28 are provided with input devices such as a keyboard and output devices such as a display.

The parts ordering system 10 provides some specific views including forms for inputting the predicted required amount and the fixed required amount for the parts. A purchaser uses a terminal 20 to access the view and input data of the predicted required amount of the parts on the form. Such data is transmitted to the parts ordering system 10 and stored in the database 12. The parts ordering system 10 calculates the predicted amount of orders and the fixed amount of orders at predetermined intervals. The calculated amounts are transmitted to the terminals 26, 28 at the suppliers by the communication means 18 through the network 24. The input or calculated data may be checked by the suppliers on the view provided by the parts ordering system 10.

According to conventional parts ordering systems, the amounts of the parts required by the purchasers within a predetermined period (for example, next month) are summarized and then the summarized amounts are ordered to suppliers about once a month, or the summarized amounts are downloaded by the suppliers at their disposal. However, since the amounts of parts required by the purchasers may vary even in a month, parts more than the amounts manufactured based on the production schedule may be required urgently or some of the parts may become unnecessary. Therefore, the suppliers tend to hold a great deal of stock more than required to keep the delivery time.

For decreasing such excessive stock, it is required to associate the predicted required amount of the parts with the amount of the parts to be actually supplied. According to the present invention, data on the predicted required amount of the parts are received from the purchasers and the predicted amount of orders calculated based on the predicted required amount are sent to the suppliers. Then, when the orders become fixed, data on the fixed amount of orders are sent to the suppliers. Therefore, the suppliers may make a production schedule based on the predicted required amount. Thus, the suppliers may right-size the stock and shorten the delivery time.

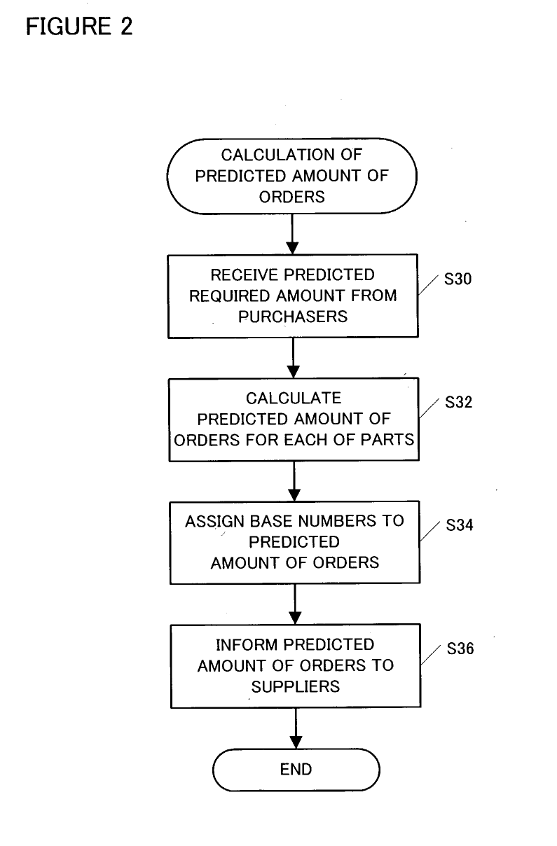

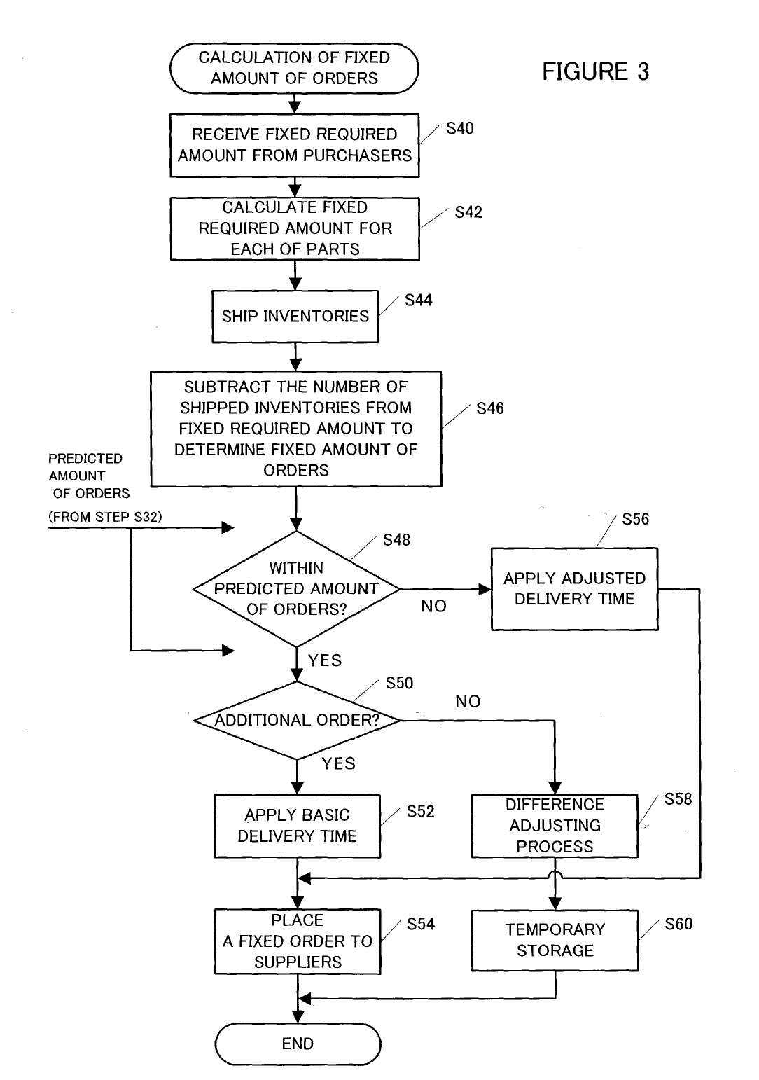

Referring to FIGS. 2 and 3, an ordering process using the parts ordering system 10 according to the invention will be described.

FIG. 2 is a flowchart for calculating predicted amount of orders. Each of the purchasers such as oversea and/or domestic distributors estimates the amount of the parts required within a predetermined period (for example, next month) based on sales performance or so. Then the purchaser uses the terminal 20 to input the estimated required amount on the view provided by the parts ordering system 10 once a month for example. The input data are transmitted to the parts ordering system 10 and stored in the database 12 (S30). Predicted amount calculator 14 summarizes the predicted required amount received from each purchaser for each of the parts at a predetermined intervals (for example, on the fixed day in every month) to determine the predicted amount of orders for the parts required within a predetermined period (S32). The predicted amount of orders is amounts that are expected to be delivered through the brand manufacturer to the purchasers by the suppliers.

The predicted amount calculator 14 assigns a unique base number to each of the predicted amount of orders (S34). The base number will be used in a process to get the relation between the predicted required amount and the predicted amount of orders.

Communication means 18 sends data on the predicted amount of orders and the base numbers to the suppliers' terminals 26, 28, which are pre-allocated depending on the type of the parts. The data may be sent through E-mail or alternatively may be displayed on the display of the terminals 26, 28 of the suppliers. Otherwise, the suppliers may download the data by the terminals 26, 28.

The predicted amount of orders are not fixed orders. However, as will be described later, when the fixed amount of orders are placed and is less than the predicted amount of orders, the suppliers are requested to ship the parts in a predetermined delivery time.

Based on the predicted amount of orders, the suppliers can make their production schedules or adjust (increase or decrease) the inventory amounts. Therefore, it is expected to shorten the delivery time in comparison with conventional parts ordering systems.

FIG. 3 is a flowchart for calculating fixed amount of orders. When the required amount of the parts are fixed for each of the purchasers, the purchaser inputs the fixed required amount by the terminal 20, which are transmitted to the parts ordering system 10 and stored in the database 12 (S40). Fixed amount calculator 16 calculates the fixed amount of orders for each of the parts at a predetermined intervals (for example, once a week or a day) (S42). The predetermined intervals may vary depending on the type of the parts.

The fixed amount calculator 16 checks the inventory status for each of the parts by searching an inventory database (not shown). When the parts are stocked, that parts are shipped to the purchasers (S44). Then, the amounts of the parts shipped to the purchasers are subtracted from the fixed required amount to determine the fixed amount of orders (S46).

The fixed amount calculator 16 compares the predicted amount of orders (calculated in step S34 and sent to the suppliers) with the cumulative fixed amount of orders calculated within the predetermined period (S48). When the cumulative fixed amount of orders is less than the predicted amount of orders, it is determined whether there may be additional orders (S50). If so, a process for placing the fixed amount of orders with the suppliers is performed (S50). In this case, because the fixed amount of orders is less than the predicted amount of orders which is sent to the supplier in advance, a predetermined basic delivery time (for example, 14 days) is applied. These fixed amount of orders are preferably assigned a unique identification number including the base number given to the predicted required amount in step S34 and then sent to the suppliers (S54).

Thus, it is possible to request the suppliers to deliver the parts in a delivery time shorter than conventional one because the predicted amount of orders are sent in advance. The predicted amount of orders are calculated at a predetermined intervals (for example, once a month). In contrast, data on the fixed amount of orders is sent at any time when the required amount becomes fixed (for example, once a week or a day) at each of the purchasers. Therefore, the required amount may not increase or decrease after data on the fixed amount of orders is sent.

When the cumulative fixed amount of orders exceeds the predicted amount of orders in the predetermined period (for example, a month) (when the answer in step S48 is NO), an adjusted delivery time (for example, 30 days) which is longer than the basic delivery time is applied to the portion exceeding the predicted amount of orders (S56) and then sent to the suppliers (S54). In this case, it is preferable to assign an identification number including the base number to the predicted amount of orders. The identification number has, for example, a six-digit base number for the predicted amount of orders and has an identification code “A” at the end of the base number when the fixed order is less than the predicted amount of orders or an identification code “B” at the end of the base number when the fixed order exceeds the predicted amount of orders. Such identification number facilitates the suppliers to determine whether the received order is less than the predicted amount of orders or not.

When the fixed amount of orders for the predetermined period is less than the predicted amount of orders (when the answer is NO in step S50), a difference adjusting process is performed (S58). The difference adjusting process is performed to deal with the remaining parts when the fixed order does not reach the predicted amount of orders because the supplier has accomplished the production schedule and/or inventory adjustments to ship the predicted amount of orders. The remaining parts is stored in the warehouse of the brand manufacturer (S60), for example. The remaining parts may be used for supplying a part of the amount of orders in step S44.

In alternative embodiment of the invention, the current fixed order status for suppliers and/or the predicted required amount by the purchasers may be browsed on a web page provided by the parts ordering system 10. Some graphs analyzing the data may be displayed there.

Although the type of parts has not been described herein, the parts ordering system according to the invention may be used to various type of parts.

According to the present invention, the predicted amount of orders are sent to the suppliers in advance and actually ordered when the required amount are fixed. Therefore, the suppliers may make their production schedules suitable for the predicted amount of orders.

What is claimed is:

1. Parts ordering system, comprising:
a database for storing predicted required amount of parts received from a plurality of purchasers;
a computer programmed to calculate predicted amount of orders of the parts within a predetermined period based on said predicted required amount, and to calculate fixed amount of orders of the parts in response to receiving fixed required amount from the purchasers; and
communication means for sending to the suppliers, via communication network, data on the orders of a first delivery time when said fixed amount of orders is less than said predicted amount of orders and sending to the suppliers, via communication network, data on the orders of a second delivery time when said fixed amount of orders exceeds said predicted amount of orders, wherein said second delivery time is longer than said first delivery time.

2. The parts ordering system according to claim 1, wherein said predicted amount of orders is assigned a unique base number and said fixed amount of orders is assigned an identification number including said base number, wherein both said base number and said identification number are sent to the suppliers.

3. The parts ordering system according to claim 1, wherein a difference adjusting process is performed when cumulative amounts of the fixed orders for the predetermined period does not reach said predicted amount of orders.

4. A parts ordering method, comprising:
storing predicted required amount of parts received from a plurality of purchasers;
calculating predicted amount of orders of the parts within a predetermined period based on said predicted required amount;
sending to suppliers data on said predicted amount of orders via communication network;
calculating fixed amount of orders of the parts in response to receiving fixed required amount from the purchasers; and
sending to the suppliers, via communication network, data on the orders of a first delivery time when said fixed amount of orders is less than said predicted amount of orders or sending to the suppliers, via communication network, data on the orders of a second delivery time when said fixed amount of orders exceeds said predicted amount of orders, wherein said second delivery time is longer than said first delivery time.

5. The parts ordering method according to claim 1, wherein said predicted amount of orders is assigned a unique base number and said fixed amount of orders is assigned an identification number including said base number, wherein both said base number and said identification number are sent to the suppliers.

6. The parts ordering method according to claim 1, wherein a difference adjusting process is performed when cumulative amounts of the fixed orders for the predetermined period does not reach said predicted amount of orders.
